(19) United States
(12) Patent Application Publication
(10) Pub. No.: US 2001/0030783 A1
(43) Pub. Date: Oct. 18, 2001

(54) Networks of optical systems

(75) Inventors: Hamid Hatami-Hanza, Ottawa (CA); Nima Ahmadvand, Ottawa (CA)

Correspondence Address: FRIEDRICH KUEFFNER, SUITE 1921, 342 MADISON AVENUE, NEY YORK, NY, 10173, US

(73) Assignee: Tellamon Photonic Networks

(21) Appl. No.: 09/834,455

(22) Filed: Apr. 12, 2001

(30) Foreign Application Priority Data
Apr. 13, 2000 (CA) 2,305,073

(51) Int. Cl. H04B 10/20; H04J 14/00; H01S 3/00

(52) U.S. Cl. 359/118; 359/333

(57) ABSTRACT

An optical network having a number of optical amplifiers utilizes the Internet Protocol (IP) to control the amplifiers via the Internet, where optical amplifiers are assigned unique Internet addresses as required.

### FIELD OF THE INVENTION

This present invention relates to optical amplifiers which are used and deployed widely in optical fiber based networks as well as to the resulting network of optical amplifiers and their control.

### BACKGROUND OF THE INVENTION

Optical fiber amplifier systems using doped fibers are the most common type of optical amplifiers that are used in the long haul wavelength division multiplexed (WDM) and submarine systems. These systems are rather expensive and consist of many active and passive optical components as well as electronic parts. As the data rate is increasing rapidly so that several tera bits/second are being transmitted through long haul optical fiber transmission lines, it becomes extremely crucial that each amplifier or cascade of optical amplifiers (or in general networks of amplifiers) work in satisfactory condition. Therefore, condition monitoring of optical fiber amplifier systems becomes an important issue.

Commonly, loop-back and optical time domain reflectometry (OTDR) are used to gather the information about the “health” of an amplifier. These methods, however, give a limited amount of information about the amplifier. Moreover, they cannot help remedy a problem from a distant location.

There is another method called “Command and Response”, that basically measures any number of parameters within the amplifier and makes it possible to control the operational parameters of the amplifier from a distant station. The distant station sends its commands and information through an amplitude modulated (AM) signal impressed on the high speed data signal and the amplifier or repeater responds back by modulating the current of the pump lasers so that the gain of the amplifier is modulated with the information and the distant station will detect and decode the information for further processing.

In the modern long haul and ultra long haul optical networks, overall gain equalization and control techniques are becoming crucial requirements. On the other hand, flexible and configurable amplifiers are needed to enable different techniques to control the optical networks. In this respect, new methods attempt to globally control the optical networks rather than to implement the traditional local control schemes. This in turn may need the application of different gain shaping and control to different optical amplifiers along the optical amplifier chain or in the network. However, this type of control is not a trivial task. This is because of the fact that the optical network optimization has to consider a very complex non-linear system with a large number of configuration parameters and options. Providing a communication system in the optical amplifiers network enables a dynamic gain control in the whole optical amplifiers network based on the knowledge of the status of the different optical amplifiers in the network.

### SUMMARY OF THE INVENTION

The present invention provides novel communication method and system based on Internet Protocol (IP). Each amplifier is assigned an IP address in order to easily monitor the performance of each amplifier and control it from a remote location through the Internet.

Each optical amplifier system has a network card with an assigned IP address and can communicate with the outside world through the Internet. Each amplifier sends or receives its command and control or any other ingoing/outgoing information through IP packets.

Accordingly, a network of optical transmission systems comprises a plurality of optical amplifiers each having a unique Internet address (IA) for controlling said optical amplifiers through the Internet via an Internet protocol (IP) network interface means.

An optical amplifier according to the present invention comprises an optical gain module; control means for controlling said gain module; and internet protocol interface means for interfacing said control means with a remote control centre.

The present invention provides a method for controlling networks of optical systems having a plurality of optical amplifiers, comprising the steps of: assigning a unique internet address to each optical amplifier; and controlling operational characteristics of an optical amplifier by commands transmitted to the unique address of the optical amplifier.

### BRIEF DESCRIPTION OF THE DRAWINGS

Exemplary embodiments of the invention will now be described with reference to the annexed drawings, in which:

FIG. 1 shows network of amplifiers and switching centres in an optical transmission network; and

FIG. 2 shows in block diagram a communication unit for interfacing with optical amplifiers shown in FIG. 1 with an IP link.

### DETAILED DESCRIPTION OF THE INVENTION

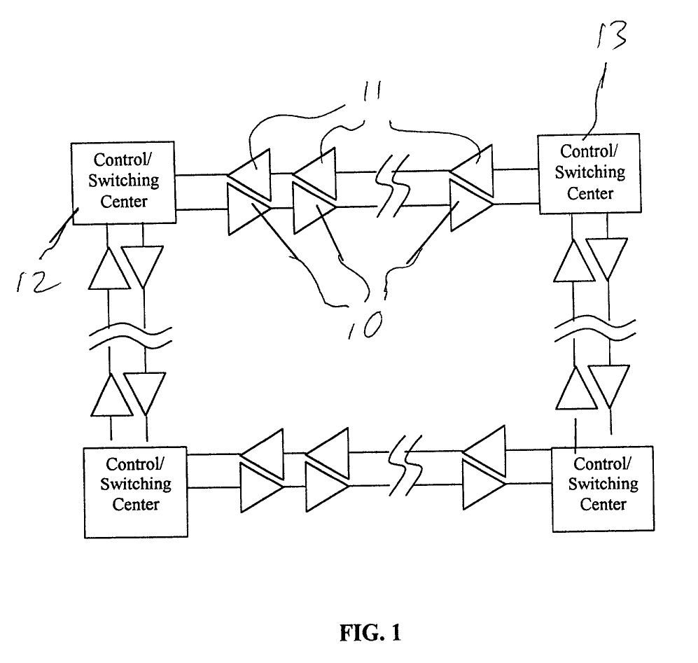

FIG. 1 shows a simple bidirectional network of optical amplifiers 10 and 11 which interconnect switching centers or central offices 12 and 13.

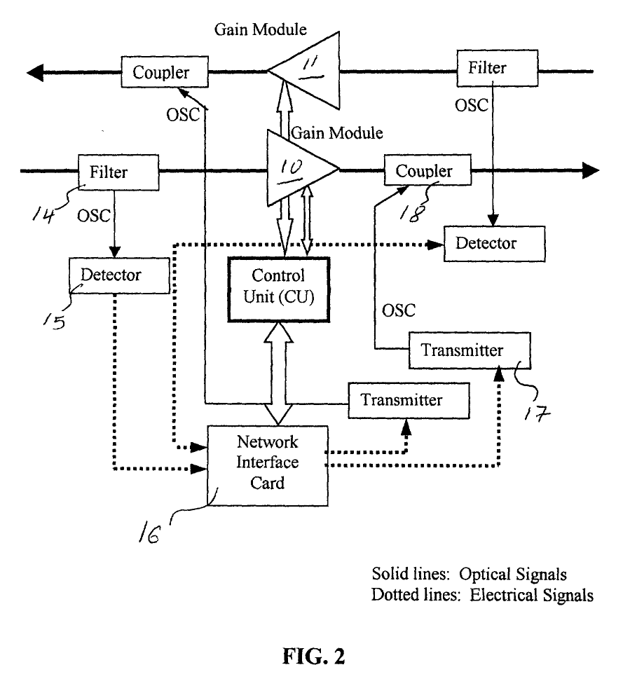

FIG. 2 shows a typical implementation of the IP link, interface for bidirectional optical amplifiers 10 and 11 in WDM systems. In this configuration, the signals are communicated through an optical supervisory channel (OSC). This channel can be selected in-band or out-of-band. The second option is preferred since this channel does not need to be amplified as discussed below and because it frees up a channel to be used as a data channel.

As shown in the figure, the OSC channel is filtered out (filter 14) at the receiving side (from both directions). For simplicity only one of the directions is discussed. The filtered channel goes through an optical detector 15, where the electrical signal is demodulated from the OSC. The detected signal is sent to a network interface card (MC) 16 to retrieve the data carried through an IP protocol. The NIC 16 first checks for the IP address of the packet. If the address matches the IP address of the optical amplifier, the corresponding packet would be checked and executed via control unit CU if it contains a command. Otherwise, it would be redirected to the next optical amplifier in the chain. During this process, the status or any other data requested by the control center or other control agents is gathered. The resulting data are sent by the NIC 16 to an optical transmitter 17 to be sent on the network via coupler 18. As shown in the figure, the laser in the transmitter 17, which is tuned to the OSC, transmits the IP packets. The optical signal is then combined on the corresponding output fiber with other amplified data channels.

As discussed above, the signal on the OSC does not need optical amplification, since it goes through signal regeneration. Bidirectional connection through the OSC can provide a fast feedback method as well as better connectivity throughout the network.

It should be noted that the control network through the OSC not only includes the optical amplifiers in the optical networks but also the control or switching centers. As a result, centralized control methods as well as distributed schemes may be used in the system.

The NIC 16 task is to communicate with the outside world as well as other amplifiers if necessary. The combined optical/electrical transmitter/receiver module sends and receives data through IP signalling in which each amplifier has an IP address, so that it can be accessed from any remote control station through the IP network. A standard, commercially available (e.g., from Motorola), IP NIC can be used in this architecture.

The Control Unit (CU), interfaces the NIC 16 and the Gain Modules 10 and 11. The CU is the agent that interprets the commands received by the NIC 16 and also sends commands or status to the NIC. At the same time, the CU controls the behaviour of the optical gain modules and monitors their performance. The CU acquires the data from various acquisition points of an optical amplifier such as input power, output power, operating temperature, pump laser powers, pump laser currents, and so on, and processes the data to evaluate the operational conditions of the amplifier.

It is often desirable to change the operating conditions of an optical amplifier based on the knowledge of the incoming optical signal characteristics and the knowledge of the conditions of the other optical amplifiers in the optical network. This introduces another reason to provide a communication means for the optical amplifiers through the optical networks.

What is claimed is:

1. A network of optical transmission systems, comprising: a plurality of optical amplifiers each having a unique internet address (IA) for controlling said optical amplifiers through the internet via an internet protocol (IP) network interface means.

2. An optical amplifier, comprising: an optical gain module; control means for controlling said gain module; and internet protocol interface means for interfacing said control means with a remote control centre.

3. A method for controlling networks of optical systems having a plurality of optical amplifiers, comprising the steps of: assigning a unique internet address to each optical amplifier; and controlling operational characteristics of an optical amplifier by commands transmitted to the unique address of the optical amplifier.
